(19) United States
(12) Patent Application Publication
(10) Pub. No.: US 2026/0112630 A1
(43) Pub. Date: Apr. 23, 2026

(54) ANODE FOR LITHIUM SECONDARY BATTERY AND LITHIUM SECONDARY BATTERY INCLUDING THE SAME

(71) Applicant: SK On Co., Ltd., Seoul (KR)

(72) Inventors: Yeon Hwa SONG, Daejeon (KR); Hyeon Soo KANG, Daejeon (KR); Ki Joo EOM, Daejeon (KR); Geon Hee YOON, Daejeon (KR); Hyun Joong JANG, Daejeon (KR)

(21) Appl. No.: 19/287,824

(22) Filed: Aug. 1, 2025

(30) Foreign Application Priority Data
Oct. 17, 2024 (KR) 10-2024-0142043

(51) Int. Cl. H01M 4/583; H01M 4/02; H01M 4/36; H01M 10/052

(52) U.S. Cl. CPC H01M 4/583; H01M 4/364; H01M 4/366; H01M 10/052; H01M 2004/021; H01M 2004/027

(57) ABSTRACT

An anode for a lithium secondary battery includes an anode current collector, a first anode mixture layer on at least one surface of the anode current collector, and a second anode mixture layer on the first anode mixture layer. The first anode mixture layer includes natural graphite, the second anode mixture layer includes artificial graphite, and the first anode mixture layer does not include a conductive material. The rapid charging performance of an anode for a lithium secondary battery may be improved.

### CROSS-REFERENCE TO RELATED APPLICATION(S)

This patent document claims the priority and benefits of Korean Patent Application No. 10-2024-0142043 filed on Oct. 17, 2024, the disclosure of which is incorporated herein by reference in its entirety.

### TECHNICAL FIELD

The disclosure and implementations disclosed in this patent document generally relate to an anode for a lithium secondary battery and a lithium secondary battery including the same.

### BACKGROUND

Recently, research into electric vehicles (EVs) that may replace fossil fuel-based vehicles, one of the main causes of air pollution, is actively being conducted, and lithium secondary batteries with high discharge voltage and output stability are mainly used as the power source for these electric vehicles (EVs).

Accordingly, development of technologies that may improve the energy density, lifespan characteristics, and rapid charging performance of lithium secondary batteries is necessary.

### SUMMARY

The present disclosure can be implemented in some embodiments to provide an anode for a lithium secondary battery having excellent rapid charging performance.

According to an aspect of the present disclosure, an anode for a lithium secondary battery having reduced electrode resistance may be provided.

In some embodiments of the present disclosure, an anode for a lithium secondary battery includes an anode current collector; a first anode mixture layer on at least one surface of the anode current collector; and a second anode mixture layer on the first anode mixture layer. The first anode mixture layer includes natural graphite, the second anode mixture layer includes artificial graphite, and the first anode mixture layer does not include a conductive material.

In some embodiments, the second anode mixture layer may not include a conductive material.

In some embodiments, the first anode mixture layer may not include artificial graphite.

In some embodiments, the first anode mixture layer may further include artificial graphite, and a weight of the natural graphite included in the first anode mixture layer may be greater than a weight of the artificial graphite included in the first anode mixture layer.

In some embodiments, the second anode mixture layer may not include natural graphite.

In some embodiments, the second anode mixture layer may further include natural graphite, and a weight of the artificial graphite included in the second anode mixture layer may be greater than a weight of the natural graphite included in the second anode mixture layer.

In some embodiments, at least one of the first anode mixture layer and the second anode mixture layer may not include a silicon-based active material.

In some embodiments, a loading weight (LW) of the second anode mixture layer may be greater than or equal to a loading weight (LW) of the first anode mixture layer.

In some embodiments, a loading weight (LW) ratio of the first anode mixture layer and the second anode mixture layer may be 5:5 to 1:9.

In some embodiments of the present disclosure, a lithium secondary battery includes the anode for a lithium secondary battery according to any one of the above-described embodiments.

### BRIEF DESCRIPTION OF DRAWINGS

Certain aspects, features, and advantages of the present disclosure are illustrated by the following detailed description with reference to the accompanying drawings.

FIG. 1 is a cross-sectional view conceptually illustrating an anode for a lithium secondary battery according to an embodiment.

FIG. 2 is a graph illustrating the results of evaluating the life performance during rapid charging for lithium secondary batteries of examples and comparative examples.

FIG. 3 is a graph illustrating the results of a reference performance test (RPT) for evaluating the life performance during rapid charging for lithium secondary batteries of examples and comparative examples.

### DETAILED DESCRIPTION

Features of the present disclosure disclosed in this patent document are described by example embodiments with reference to the accompanying drawings.

Hereinafter, the technology disclosed in this specification and implementation examples thereof will be described in detail. However, the embodiment of the technology may be modified to have various other forms, and the scope thereof is not limited to the implementation examples described below. In addition, the technology. 5 disclosed in this specification may be applied not only by being limited to the configurations of the implementation examples described below, but may also be configured by selectively combining all or part of respective implementation examples so that various modifications may be made.

To improve the performance of a lithium secondary battery, a technology is required that may secure excellent levels of rapid charging performance while increasing the energy density of the lithium secondary battery. However, as the energy density of the lithium secondary battery increases, the electrode resistance may increase, and thus, the rapid charging performance of the lithium secondary battery may deteriorate.

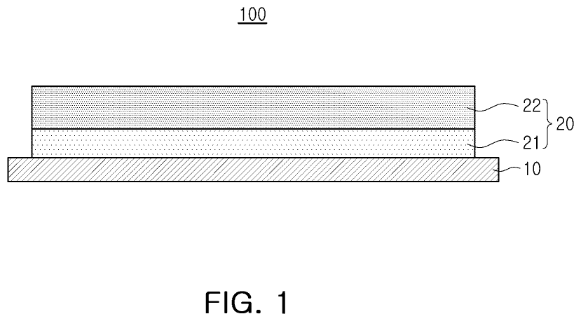

According to an implementation example of the present disclosure, the electrode resistance may be lowered by reducing the content of the conductive material in the anode of the multilayer structure or excluding the conductive material. Hereinafter, implementation examples of the present disclosure will be described in detail with reference to FIGS. 1 to 3.

FIG. 1 is a cross-sectional view conceptually illustrating an anode for a lithium secondary battery according to an embodiment.

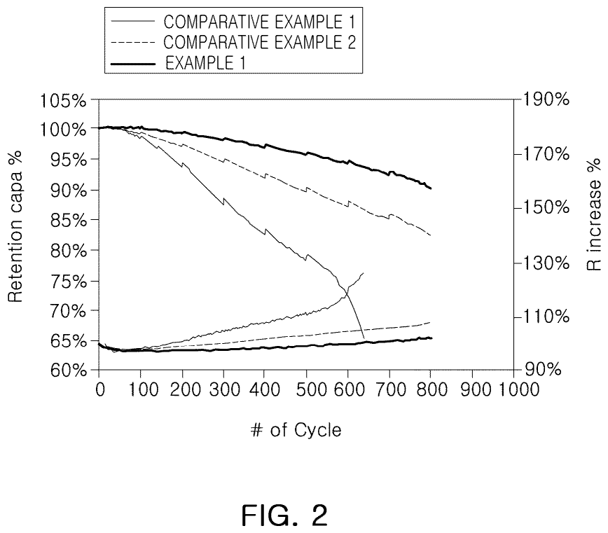

FIG. 2 is a graph illustrating the results of evaluating the life performance during rapid charging for lithium secondary batteries of examples and comparative examples.

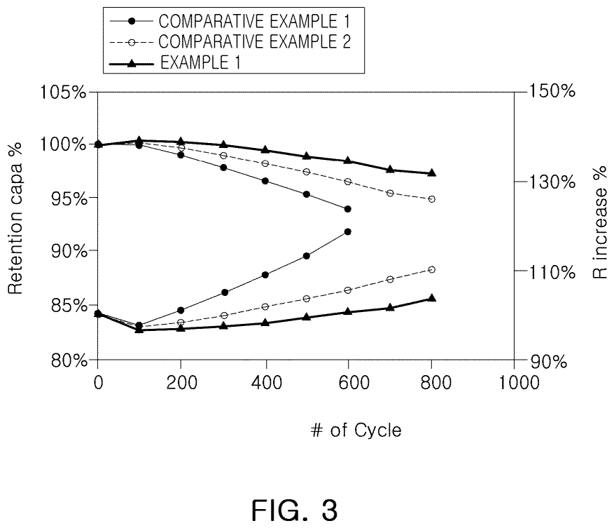

FIG. 3 is a graph illustrating the results of a reference performance test (RPT) for evaluating the life performance during rapid charging for lithium secondary batteries of examples and comparative examples.

### Anode for Lithium Secondary Battery

An anode 100 for a lithium secondary battery according to an embodiment includes an anode current collector 10, a first anode mixture layer 21 on at least one surface of the anode current collector 10, and a second anode mixture layer 22 on the first anode mixture layer. The first anode mixture layer 21 includes natural graphite, the second anode mixture layer 22 includes artificial graphite, and the first anode mixture layer 21 does not include a conductive material.

The components of the anode current collector 10 are not particularly limited. For example, the anode current collector may be a plate or foil formed of at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. The thickness of the anode current collector is not particularly limited. For example, the thickness of the anode current collector may be 0.1 to 50 μm.

The anode 100 for a lithium secondary battery includes an anode mixture layer 20 on at least one surface of the anode current collector 10, and the anode mixture layer includes a first anode mixture layer 21, and a second anode mixture layer 22 on the first anode mixture layer (see FIG. 1).

The first anode mixture layer 21 may be a layer including natural graphite, as a lower layer adjacent to the anode current collector 10. The natural graphite is a high-capacity anode active material with a relatively large capacity, and may have excellent adhesion to the anode current collector 10. Accordingly, when the first anode mixture layer 21 adjacent to the anode current collector 10 includes natural graphite, the adhesion between the anode current collector 10 and the anode mixture layer 20 may be improved, and the energy density of the anode may be improved.

In some implementation examples, the first anode mixture layer 21 may not include artificial graphite. For example, the first anode mixture layer 21 may be a layer including only natural graphite as an anode active material.

In some implementations, the first anode mixture layer 21 may further include artificial graphite, and the weight of the natural graphite included in the first anode mixture layer 21 may be greater than the weight of the artificial graphite included in the first anode mixture layer 21. For example, the first anode mixture layer 21 may be a layer including a combination of natural graphite and artificial graphite as an anode active material. The weight ratio of the natural graphite and the artificial graphite included in the first anode mixture layer 21 may be, for example, 51:49 to 99:1.

The second anode mixture layer 22 may be a layer including artificial graphite as an upper layer adjacent to the outer surface and spaced apart from the anode current collector 10. The artificial graphite is an anode active material with relatively excellent durability, and may have excellent output characteristics. Accordingly, when the second anode mixture layer 22 adjacent to the outer surface includes artificial graphite, the volume change of the mixture layer during the battery charge/discharge process may be reduced, and the lithium ions may be easily entered and released, thereby improving the output characteristics of the secondary battery.

In some embodiments, the second anode mixture layer 22 may not include natural graphite. For example, the second anode mixture layer 22 may be a layer including only artificial graphite as an anode active material.

In some embodiments, the second anode mixture layer 22 may further include natural graphite, and the weight of the artificial graphite included in the second anode mixture layer 22 may be greater than the weight of the natural graphite included in the second anode mixture layer 22. For example, the second anode mixture layer 22 may be a layer including a combination of natural graphite and artificial graphite as an anode active material. The weight ratio of natural graphite and artificial graphite included in the second anode mixture layer 22 may be, for example, 49:51 to 1:99.

In some implementation examples, at least one of the natural graphite and the artificial graphite may include a carbon coating layer on the surface. The carbon coating layer may be formed on at least a portion of the surface of the graphite-based active material, and may increase the adhesive force between the anode current collector 10 and the anode mixture layer 20 and improve the durability of the active material. The components, manufacturing method, and the like of the carbon coating layer are not particularly limited. For example, the carbon coating layer may be formed by mixing raw materials such as hard carbon, soft carbon, heavy oil, or pitch with the graphite-based active material and then heat-treating at 700 to 1300° C. for 3 to 6 hours.

In some embodiments, the natural graphite may have a specific surface area (BET) of 1.90 to 3.50 m²/g, and the artificial graphite may have a BET of 1.50 to 2.50 m²/g.

In some embodiments, the natural graphite may have a tap density of 1.00 to 1.20 g/cc, and the artificial graphite may have a tap density of 0.85 to 0.95 g/cc.

In some embodiments, the natural graphite may have an average particle diameter (D50) of 10.0 to 14.0 μm, and the artificial graphite may have an average particle diameter (D50) of 9.0 to 13.0 μm.

In some implementations, at least one of the first anode mixture layer 21 and the second anode mixture layer 22 may not include a silicon-based active material. For example, the first anode mixture layer 21 may be a layer including only natural graphite, which is a graphite-based active material, as an anode active material, and the second anode mixture layer 22 may be a layer including only artificial graphite, which is a graphite-based active material, as an anode active material.

The silicon-based active material is not particularly limited as long as it contains silicon, and may be an active material that may be alloyed with lithium (Li). For example, the silicon-based active material may be at least one selected from the group consisting of silicon (Si), silicon oxide (SiOx; 0<x<2), metal-doped silicon oxide (SiOx; 0<x<2), carbon-coated silicon oxide (SiOx; 0<x<2), silicon-carbon composite (Si—C), and silicon alloy.

The content of the graphite-based active material included in the anode mixture layer 20 is not particularly limited. For example, the content of natural graphite included in the first anode mixture layer 21 and the content of artificial graphite included in the second anode mixture layer 22 may be 70 to 99 wt %, respectively.

The anode 100 for a lithium secondary battery may have a low content of conductive material based on the entire anode since the first anode mixture layer 21 does not include a conductive material. In some implementation examples, the second anode mixture layer 22 may not include a conductive material. In this case, since neither the first anode mixture layer 21 nor the second anode mixture layer 22 includes a conductive material, the conductive material may be completely excluded from the anode 100 for a lithium secondary battery. Accordingly, the anode 100 for a lithium secondary battery may have a reduced resistance, thereby improving the rapid charging performance of the secondary battery.

The conductive material is a material that has conductivity while not causing side reactions with other elements in the electrode, and may be a different component from the active material participating in the electrochemical reaction in the electrode due to battery operation. The type of the conductive material is not particularly limited. For example, the conductive material may be at least one selected from a particle-shaped carbon material and a carbon fiber material. The particle-shaped carbon material may be carbon black such as Super-P or Super-C, acetylene black, or Ketjen black. The carbon fiber material may be carbon fiber, carbon nanotube (CNT), or vapor-grown carbon fiber (VGCF).

In some embodiments, the conductive material may not be natural graphite or artificial graphite. For example, the natural graphite and artificial graphite included in the anode 100 for a lithium secondary battery are anode active materials that are not conductive materials, and the anode including at least one of natural graphite and artificial graphite as the conductive material may be different from the anode 100 for a lithium secondary battery.

In some implementations, the first anode mixture layer 21 and the second anode mixture layer 22 may each further include a binder. The binder is not particularly limited. For example, the binder may be at least one of a rubber-based binder such as styrene-butadiene rubber (SBR), fluorine-based rubber, ethylene propylene rubber, butadiene or silane-based rubber; rubber, isoprene rubber, a cellulose-based binder such as carboxymethyl cellulose (CMC), hydroxypropyl methyl cellulose, methyl cellulose, or an alkali metal salt thereof; and combinations thereof.

When the first anode mixture layer 21 and the second anode mixture layer 22 each further include a binder, the content of the binder is not particularly limited. For example, the content of the binder included in the first anode mixture layer 21 and the content of the binder included in the second anode mixture layer 22 may be 0.1 to 10 wt %, respectively.

In some implementations, the loading weight (LW) of the second anode mixture layer 22 may be greater than or equal to the loading weight (LW) of the first anode mixture layer 21. For example, the loading weight (LW) ratio of the first anode mixture layer 21 and the second anode mixture layer 22 may be 5:5 to 1:9. When the loading weight (LW) relationship between the first anode mixture layer 21 and the second anode mixture layer 22 is as described above, the energy density of the anode may be improved to a high level while also securing rapid charging performance.

In some implementations, the loading weight of the first anode mixture layer 21 may be 1.5 to 8.0 mg/cm². In some implementations, the loading weight of the second anode mixture layer 22 may be 8.0 to 14.0 mg/cm².

In some implementations, the electrode resistance value of the anode 100 for a lithium secondary battery may be less than 0.049 Ω·cm. For example, the electrode resistance value of the anode 100 for a lithium secondary battery may be 0.045 Ω·cm or less or 0.040 Ω·cm or less, 0.001 Ω·cm or more, 0.01 Ω·cm or more, or 0.03 Ω·cm or more.

In some implementations, the interface resistance value of the anode 100 for a lithium secondary battery may be less than 0.017 Ω cm. For example, the interface resistance value of the anode 100 for a lithium secondary battery may be 0.015 Ω cm or less, or less than 0.010 Ω cm, and may be 0.001 Ω cm or more, 0.003 Ω cm or more, or 0.005 Ω cm or more.

The method for manufacturing an anode 100 for a lithium secondary battery according to any one of the above-described embodiments may include a step of forming an anode mixture layer 20 on at least one surface of an anode current collector 10. In the step of forming the anode mixture layer 20 on at least one surface of the anode current collector 10, the first anode mixture layer 21 and the second anode mixture layer 22 may be formed simultaneously or sequentially.

For example, the first anode mixture layer 21 may be formed by applying a first anode slurry on at least one surface of the anode current collector 10 and drying the applied first anode slurry at 80 to 120° C. In addition, the second anode mixture layer 22 may be formed by applying the second anode slurry on the first anode mixture layer 21 and drying the applied second anode slurry at 80 to 120° C. The method of applying the slurry is not particularly limited. For example, the application of the slurry may use a method such as bar coating, casting, or spraying.

The first anode slurry and the second anode slurry may each further include a solvent. The solvent is not particularly limited. For example, the solvent may be water. The amount of the solvent may be appropriately adjusted in consideration of the target solid content, viscosity value, or the like of the slurry.

### Lithium Secondary Battery

A lithium secondary battery according to an embodiment includes an anode 100 for a lithium secondary battery according to any one of the above-described embodiments. For example, the lithium secondary battery may include a unit cell including the anode 100 for a lithium secondary battery, a cathode, and a separator. The separator may be disposed between the cathode and the anode.

The cathode may include a cathode current collector; and a cathode mixture layer on at least one surface of the cathode current collector.

The components of the cathode current collector are not particularly limited. For example, the cathode current collector may be a plate or foil formed of at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. The thickness of the cathode current collector is not particularly limited. For example, the thickness of the cathode current collector may be 0.1 to 50 μm.

The cathode mixture layer may include a cathode active material. The cathode active material is not particularly limited and may include a compound capable of reversibly intercalating and deintercalating lithium ions. For example, the cathode active material may include a lithium-nickel metal oxide. The lithium-nickel metal oxide may further include at least one of cobalt (Co), manganese (Mn), and aluminum (Al).

In some embodiments, the cathode active material or the lithium-nickel metal oxide may include a layered structure or a crystal structure represented by the following chemical formula 1.

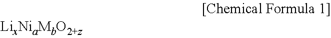

In the chemical formula 1, 0.9≤x≤1.2, 0.6≤a≤0.99, 0.01≤b≤0.4, and −0.5≤z≤0.1. As described above, M may include Co, Mn, and/or Al.

The chemical structure represented by the chemical formula 1 above represents a bonding relationship included in the layered structure or crystal structure of the cathode active material and does not exclude other additional elements. For example, M includes Co and/or Mn, and Co and/or Mn may be provided as the main active element of the cathode active material together with Ni. The chemical formula 1 above is provided to express the bonding relationship of the main active element and should be understood as encompassing the introduction and substitution of additional elements.

In some implementations, auxiliary elements may be further included in addition to the main active element to enhance the chemical stability of the cathode active material or the layered structure/crystal structure. The auxiliary elements may be incorporated together in the layered structure/crystal structure to form a bond, and in this case, it should be understood that they are included within the chemical structure range represented by the chemical formula 1.

The auxiliary element may include at least one of, for example, Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. The auxiliary element may also act as an auxiliary active element contributing to the capacity/output activity of the cathode active material together with Co or Mn, such as Al. For example, the cathode active material or the lithium-nickel metal oxide may include a layered structure or a crystal structure represented by the following chemical formula 1-1.

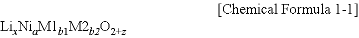

In the chemical formula 1-1, M1 may include Co, Mn, and/or Al. M2 may include the auxiliary element described above. In chemical formula 1-1, 0.9≤x≤1.2, 0.6≤a≤0.99, 0.01≤b1+b2≤0.4, and −0.5≤z≤0.1 may be satisfied.

The cathode active material may further include a coating element or a doping element. For example, elements substantially identical to or similar to the above-described auxiliary elements may be used as the coating element or the doping element. For example, the above-described elements may be used alone or in combination of two or more as the coating element or the doping element.

The coating element or the doping element may be present on the surface of the lithium-nickel metal oxide particle, or may penetrate through the surface of the lithium-nickel metal oxide particle and be included in the bonding structure represented by the chemical formula 1 or the chemical formula 1-1.

The cathode active material may include a nickel-cobalt-manganese (NCM)-based lithium oxide. In this case, an NCM-based lithium oxide having an increased nickel content may be used.

The content of Ni (for example, the mole fraction of nickel among the total moles of nickel, cobalt, and manganese) in the NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (for example, LiFePO₄).

In some embodiments, the cathode active material may include a Mn-rich active material, a Li rich layered oxide (LLO)/Over Lithiated Oxide (OLO) active material, or a Co-less active material having a chemical structure or crystal structure represented by chemical formula 2.

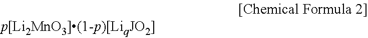

In the chemical formula 2, 0<p<1, 0.9≤q≤1.2, and J may include at least one element among Mn, Ni, Co, Fe, Cr, V, Cu, Zn, Ti, Al, Mg, and B.

The cathode mixture layer may further include a binder. The binder is not particularly limited. For example, the binder may include one type, two or more types of styrene butadiene rubber (SBR), polytetrafluoroethylene, polyvinylidene fluoride, vinylidene fluoride/hexafluoropropylene copolymer, polyacrylonitrile, and polymethyl methacrylate.

The cathode mixture layer may further include a conductive material. The conductive material is not particularly limited. For example, the conductive material may include one type, two or more types of graphite such as natural graphite or artificial graphite; a carbon-based material such as carbon black, acetylene black, Ketjen black, channel black, furnace black, lamp black, thermal black, carbon fibers, or carbon nanotubes (CNTs); metal powder particles or metal fibers such as copper, nickel, aluminum, or silver; conductive whiskers such as zinc oxide or potassium titanate; conductive metal oxides such as titanium oxide; or a conductive polymer such as polyphenylene derivatives.

The separator is not particularly limited. For example, the separator may include a porous polymer film manufactured from a polyolefin polymer such as an ethylene homopolymer, a propylene homopolymer, an ethylene/butene copolymer, an ethylene/hexene copolymer, an ethylene/methacrylate copolymer, or the like. In addition, the separator may include a nonwoven fabric formed from high-melting-point glass fibers, polyethylene terephthalate fibers, or the like.

In some embodiments, the lithium secondary battery may be manufactured by storing the above-described unit cell in a pouch, which is a battery case, and then injecting an electrolyte.

The electrolyte may include an organic solvent and a lithium salt. The organic solvent acts as a medium through which ions involved in the electrochemical reaction of the battery may move, and for example, carbonate-based, ester-based, ether-based, ketone-based, alcohol-based, or aprotic solvents may be used alone or in a mixture of two or more types, and the mixing ratio in the case of using two or more types in a mixture may be appropriately adjusted according to the desired battery performance.

The lithium salt is dissolved in the organic solvent and acts as a source of lithium ions in the battery, and is a substance that enables the basic operation of a lithium secondary battery and promotes the movement of lithium ions between the cathode and the anode. A known substance may be used as the lithium salt at a concentration appropriate for the purpose. The electrolyte may further include a known solvent and a known additive to improve charge/discharge characteristics, flame retardancy characteristics, and the like, as needed.

In some embodiments, the unit cell may include a solid electrolyte instead of a separator between the cathode and the anode. The solid electrolyte is not particularly limited, and may be, for example, an oxide-based solid electrolyte, a sulfide-based solid electrolyte, or a polymer-based solid electrolyte.

### EXAMPLE

### 1. Manufacturing of Anode and Secondary Battery

### 1) Manufacturing of Anode

### (1) Example 1

A first anode slurry was prepared by mixing 98.4 wt % of natural graphite and 1.6 wt % of a binder (styrene-butadiene rubber (SBR) and carboxymethyl cellulose (CMC) as a thickener) with a solvent (water), and a second anode slurry was prepared by adding artificial graphite instead of natural graphite in the first anode slurry. The first anode slurry was applied to one surface of an anode current collector (Cu-Foil) to form a first anode mixture layer.

Thereafter, the second anode slurry was applied onto the first anode mixture layer to form a second anode mixture layer, and then the first anode mixture layer and the second anode mixture layer were simultaneously dried and rolled to manufacture an anode. At this time, the first anode mixture layer had a loading weight (LW) of 30% of the total loading weight (LW), and the second anode mixture layer had a loading weight (LW) of 70% of the total loading weight (LW).

### (2) Comparative Example 1

It was manufactured in the same manner as in Example 1, but a dot-shaped conductive material (graphite-based conductive material, artificial graphite with D50 of 2-4 μm) was further added to each of the first anode slurry and the second anode slurry so that the dot-shaped conductive material (graphite-based conductive material) was 3 wt % of the total solid content based on the solid content weight, thereby manufacturing an anode of Comparative Example 1 having a conductive material content of 3 wt % based on the entire anode mixture layer.

### (3) Comparative Example 2

Manufactured in the same manner as Example 1, but by adding a dot-shaped conductive material (graphite-based conductive material) to the first anode slurry so that the dot-shaped conductive material (graphite-based conductive material) accounts for 3 wt % of the total solid content based on the solid content weight, and thus an anode of Comparative Example 2 having a conductive material content of 0.9 wt % based on the entire anode mixture layer was manufactured.

### 2) Manufacturing of Secondary Battery

A slurry containing a single-crystal cathode active material (a single-particle-shaped active material having a nickel content of 75 wt %) was applied and dried on a cathode current collector (Al-foil) to manufacture a cathode. The secondary battery cell manufactured by interposing a polyolefin separator between the cathode and anode manufactured as described above was placed in a secondary battery pouch, and then an electrolyte solution containing 1M LiPF6 dissolved in a solvent mixed with ethylene carbonate (EC) and diethyl carbonate (DEC) was injected into the secondary battery pouch, and then sealed to manufacture a pouch-type lithium secondary battery. The manufactured pouch-type lithium secondary battery was applied as a secondary battery sample of Examples and Comparative Examples.

### 2. Evaluation of Anode and Secondary Battery

### 1) Electrode Resistance

The results of measuring the bulk resistance of the anode using an electrode resistance measuring device (XF057 from HIOKI) are illustrated in Table 1 below. At this time, the measurement current and voltage conditions were set to 1 mA and 10 V, respectively.

### 2) Interface Resistance

The results of measuring the interface resistance between the anode current collector and the first anode mixture layer using an electrode resistance measuring device (XF057 from HIOKI) are illustrated in Table 1 below. At this time, the measurement current and voltage conditions were set to 1 mA and 10 V, respectively.

### 3) Life Performance During Rapid Charging

The results of evaluating the life performance during rapid charging by repeatedly performing charge/discharge cycles on the secondary battery sample are illustrated in FIG. 2. At this time, the charge/discharge cycle was performed by charging the secondary battery sample to 77% SOC for 20 minutes at 25° C. and discharging to 11% SOC at a constant current of 1 C.

In addition, the results of evaluating the life performance during rapid charging every 100 cycles by performing a reference performance test (RPT) on the secondary battery sample are illustrated in FIG. 3. RPT was performed by charging the secondary battery sample to SOC 100% with Constant current/Constant voltage (CC/CV) of 0.3 C/4.25 V (0.05 C cut-off) at 25° C., and then discharging to SOC 0% at 0.3 C as one cycle, and then performing a total of three cycles. The capacity of the third cycle was used as the reference capacity, and the charge/discharge cycle was repeated thereafter. At this time, the charge/discharge cycle was performed by charging the secondary battery sample to SOC 77% for 20 minutes at 25° C., and discharging to SOC 11% with a constant current of 1 C.

Meanwhile, in the case of the capacity retention rate (Retention Capa %), which is one of the indicators for evaluating the life performance during rapid charging, the discharge capacity retention rate according to the number of cycles was calculated as a % and displayed on the left y-axis of the graph. In addition, for the resistance increase rate (R increases %), which is another indicator for evaluating life performance during rapid charging, the discharge resistance increase rate according to the number of cycles was calculated as a % and displayed on the y-axis on the right side of the graph.

TABLE 1

| | Conductive material | | | |
|---|---|---|---|---|
| | included (◯) or not (X) | | | |
| | 1st Anode | 2nd Anode | Electrode | Interface |
| | Mixture Layer | Mixture Layer | Resistance | Resistance |
| Classification | (Lower Layer) | (Upper Layer) | (Ω · cm) | (Ω · cm) |
| Example 1 | X | X | 0.040 | 0.007 |
| Comparative | ◯ | ◯ | 0.049 | 0.017 |
| Example 1 | | | | |
| Comparative | ◯ | X | 0.041 | 0.010 |
| Example 2 | | | | |

Referring to Table 1, in the case of the anodes of Comparative Examples 1 and 2, where the lower layer includes a conductive material, the electrode resistance and interface resistance were relatively high. In detail, the anode of Comparative Example 1, where both the upper and lower layers include a conductive material, was found to be unsuitable because the electrode resistance and interface resistance were very high. On the other hand, in the case of the anode of Example 1, where neither the upper nor lower layers included a conductive material, both the electrode resistance and interface resistance were found to be relatively low.

Referring to FIGS. 2 and 3, in the case of the secondary batteries that applied the anodes of Comparative Examples 1 and 2, where the lower layer includes a conductive material, the capacity retention rate decreased and the resistance increase rate increased as the number of cycles increased, resulting in insufficient life performance during rapid charging. In detail, the anode of Comparative Example 1, where both the upper and lower layers included a conductive material, was found to have significantly insufficient life performance during rapid charging. On the other hand, in the case of the secondary battery using the anode of Example 1, which does not include conductive material in both the upper and lower layers, the capacity retention rate is maintained at a high level even when the number of cycles increases, and the resistance increase rate is maintained low, exhibiting excellent life performance during rapid charging.

Considering these results, it is determined that in an anode where the lower layer includes natural graphite and the upper layer includes artificial graphite, if the lower layer does not include conductive material as in Example 1, the electrode resistance may be lowered and the rapid charging performance may be improved.

As set forth above, according to an embodiment, the rapid charging performance of an anode for a lithium secondary battery may be improved.

According to an embodiment, electrode resistance of an anode for a lithium secondary battery may be reduced.

Only specific examples of implementations of certain embodiments are described. Variations, improvements and enhancements of the disclosed embodiments and other embodiments may be made based on the disclosure of this patent document.

### DESCRIPTION OF REFERENCE NUMERALS

10: Anode current collector
20: Anode mixture layer
21: First anode mixture layer
22: Second anode mixture layer
100: Anode for a lithium secondary battery

What is claimed is:

1. An anode for a lithium secondary battery comprising:
an anode current collector;
a first anode mixture layer on at least one surface of the anode current collector; and
a second anode mixture layer on the first anode mixture layer,
wherein the first anode mixture layer includes natural graphite,
the second anode mixture layer includes artificial graphite, and
the first anode mixture layer does not include a conductive material.

2. The anode for a lithium secondary battery of claim 1, wherein the second anode mixture layer does not include a conductive material.

3. The anode for a lithium secondary battery of claim 1, wherein the first anode mixture layer does not include artificial graphite.

4. The anode for a lithium secondary battery of claim 1, wherein the first anode mixture layer further includes artificial graphite, and
a weight of the natural graphite included in the first anode mixture layer is greater than a weight of the artificial graphite included in the first anode mixture layer.

5. The anode for a lithium secondary battery of claim 1, wherein the second anode mixture layer does not include natural graphite.

6. The anode for a lithium secondary battery of claim 1, wherein the second anode mixture layer further includes natural graphite, and
a weight of the artificial graphite included in the second anode mixture layer is greater than a weight of the natural graphite included in the second anode mixture layer.

7. The anode for a lithium secondary battery of claim 1, wherein at least one of the first anode mixture layer and the second anode mixture layer does not include a silicon-based active material.

8. The anode for a lithium secondary battery of claim 1, wherein a loading weight (LW) of the second anode mixture layer is greater than or equal to a loading weight (LW) of the first anode mixture layer.

9. The anode for a lithium secondary battery of claim 1, wherein a loading weight (LW) ratio of the first anode mixture layer and the second anode mixture layer is 5:5 to 1:9.

10. A lithium secondary battery comprising the anode for a lithium secondary battery according to claim 1.
